(19) United States
(12) Patent Application Publication
(10) Pub. No.: US 2026/0170297 A9
(43) Pub. Date: Jun. 18, 2026

(54) RESERVOIR COMPUTING NETWORK OPTIMIZATION METHOD AND RELATED APPARATUS

(71) Applicant: INSTITUTE OF MICROELECTRONICS, CHINESE ACADEMY OF SCIENCES, Beijing (CN)

(72) Inventors: Xiaoxin Xu, Beijing (CN); Wenxuan Sun, Beijing (CN); Woyu Zhang, Beijing (CN); Jie Yu, Beijing (CN); Yi Li, Beijing (CN); Dashan Shang, Beijing (CN); Jinru Lai, Beijing (CN); Danian Dong, Beijing (CN)

(21) Appl. No.: 19/105,264

(22) PCT Filed: Oct. 12, 2022
(86) PCT No.: PCT/CN2022/124762

§ 371 Date: Feb. 20, 2025

(30) Foreign Application Priority Data
Aug. 22, 2022 (CN) 202211009477.7

(51) Int. Cl. G06N 3/044; G06N 3/0495; G06N 3/0985

(52) U.S. Cl. CPC G06N 3/044; G06N 3/0495; G06N 3/0985

(57) ABSTRACT

Disclosed in the present application are a reservoir computing network optimization method and a related apparatus. The method comprises: sampling an input signal to obtain a sampling signal; performing quantization processing on the sampling signal by means of at least two kinds of quantization modes, so as to obtain at least two kinds of digital signals, values of elements in different digital signals being different; inputting voltage pulses corresponding to the elements in the different digital signals into reservoirs constructed by different quantities of virtual nodes, so as to extract signal features of the input signal in different quantization modes by the different reservoirs. By quantizing signals in different modes and inputting same into reservoirs constructed by different quantities of virtual nodes, the richness of internal states of the reservoirs can be improved, thereby further improving the signal identification accuracy of a reservoir system.

The present application claims priority to Chinese Patent Application No. 202211009477.7, titled “RESERVOIR COMPUTING NETWORK OPTIMIZATION METHOD AND RELATED APPARATUS”, filed on Aug. 22, 2022 with the China National Intellectual Property Administration, which is incorporated herein by reference in its entirety.

### FIELD

The present disclosure relates to the technical field of artificial intelligence, in particular to a method for optimizing a reservoir computing network and a related apparatus.

### BACKGROUND

With the rapid development of artificial intelligence technology, it has become a research focus to realize the neuromorphic computing of artificial intelligence by imitating the mechanism of neurons and synapses that constitute the human brain. In the neuromorphic computing, a reservoir computing (Reservoir Computing, RC) derived from a conventional recurrent neural network (Recurrent Neural Network, RNN) has been widely used in the fields of dynamic system identification, time series detection, and the like because of the RC having low training cost and simple hardware implementation.

The accuracy of signal recognition of the reservoir system is closely related to the richness of internal states of the reservoir. In the conventional memristor-based reservoir computing technology, the richness of the internal states of the reservoir may be improved through the inherent difference between the memristors. However, when the process conditions and parameters of the device are determined, the richness of the reservoir is determined accordingly and cannot be adjusted according to a specific task type. If the device is redesigned according to different task types each time, the cost of hardware will be too high.

### SUMMARY

Based on the above problem, the present disclosure provides a method for optimizing a reservoir computing network and a related apparatus, so as to improve the accuracy of signal recognition of a reservoir system.

Embodiments of the present disclosure provide the following technical solutions:

In a first aspect, the present disclosure provides a method for optimizing a reservoir computing network, the method includes:
sampling an input signal to obtain a sampled signal;
performing a quantization processing on the sampled signal by at least two quantization modes to obtain at least two digital signals, wherein values of elements in different digital signals are different; and
inputting voltage pulse signals corresponding to the elements in the different digital signals to reservoirs constructed by different numbers of virtual nodes, so that different reservoirs extract signal characteristics of the input signal in different quantization modes.

Optionally, the at least two digital signals include at least a first digital signal and a second digital signal, and inputting the voltage pulse signals corresponding to the elements in the different digital signals to the reservoirs constructed by the different numbers of virtual nodes includes:
inputting voltage pulse signals corresponding to a first number of elements in the first digital signal to a first reservoir constructed by a first number of virtual nodes, in sequence; and
inputting voltage pulse signals corresponding to a second number of elements in the second digital signal to a second reservoir constructed by a second number of virtual nodes, in sequence.

Optionally, the at least two quantization modes include at least a first quantization mode and a second quantization mode, the first quantization mode corresponds to a first bit number, the second quantization mode corresponds to a second bit number, and performing the quantization processing on the sampled signal by the at least two quantization modes to obtain the at least two digital signals includes:
determining a first value interval, based on a maximum value and a minimum value of the sampled signal and the first bit number;
obtaining a first digital signal according to a correspondence between an amplitude of the sampled signal and the first value interval;
determining a second value range, based on a maximum value and a minimum value of the sampled signal, and the second bit number; and
obtaining a second digital signal according to a correspondence between the amplitude of the sampled signal and the second value interval.

Optionally, bit number applied in the quantization modes is related to performance of a memristor.

Optionally, the digital signals are binary encoded digital signals.

In a second aspect, an embodiment of the present disclosure provides an apparatus for optimizing a reservoir computing network, the apparatus includes:
a sampling module, a quantization module, and an input module;
the sampling module is configured to sample an input signal to obtain a sampled signal;
the quantization module is configured to quantify the sampled signal by at least two quantization modes to obtain at least two digital signals, wherein values of elements in different digital signals are different; and
the input module is configured to input voltage pulse signals corresponding to the elements in different digital signals to reservoirs constructed by different numbers of virtual nodes, so that the different reservoirs extract signal characteristics of the input signal in different quantization modes.

Optionally, the at least two digital signals include a first digital signal and a second digital signal, and the input module is specifically configured to:
input voltage pulse signals corresponding to a first number of elements in the first digital signal to a first reservoir constructed by a first number of virtual nodes, in sequence; and
input voltage pulse signals corresponding to a second number of elements in the second digital signal to a second reservoir constructed by a second number of virtual nodes, in sequence.

Optionally, the at least two quantization modes include at least a first quantization mode and a second quantization mode, the first quantization mode corresponds to a first bit number, the second quantization mode corresponds to a second bit number, the sampled signal is quantified by the at least two quantization modes to obtain the at least two digital signals, and the quantization module is specifically configured to:
determine a first value interval, based on a maximum value and a minimum value of the sampled signal and the first bit number;
obtain a first digital signal according to a correspondence between an amplitude of the sampled signal and the first value interval;
determine a second value range, based on a maximum value and a minimum value of the sampled signal, and the second bit number; and
obtain a second digital signal according to a correspondence between the amplitude of the sampled signal and the second value interval.

In a third aspect, an embodiment of the present disclosure provides a device for optimizing a reservoir computing network, the device includes:
a memory and a processor;
the memory is configure to store a computer program;
the processor is configured, when executing the computer program, to implement steps of the method for optimizing the reservoir computing network according to any one as described in the first aspect.

In a fourth aspect, an embodiment of the present disclosure provides a computer readable storage medium.

The computer readable storage medium has stored thereon a computer program, which, when the program is executed by a processor, cause the processor to implement steps of the method for optimizing the reservoir computing network according to any one as described in the first aspect.

The present disclosure has the following advantages compared to the prior art.

In a signal processing method provided in the present disclosure, an input signal is sampled to obtain a sampled signal; quantization processing is performed on the sampled signal by at least two quantization modes to obtain at least two digital signals, values of elements in different digital signals are different; and voltage pulse signals corresponding to the elements in the different digital signals are input to reservoirs constructed by different numbers of virtual nodes, so that different reservoirs extract signal characteristics of the input signal in different quantization modes.

According to the present disclosure, different reservoirs are constructed through different numbers of virtual nodes, different digital signals are obtained through performing different quantization processing on the sampled signal using different quantization modes, and different digital signals are input to different reservoirs constructed through different numbers of virtual nodes, so that the richness of the reservoirs can be improved, thereby improving the accuracy of signal recognition of the reservoir system.

### BRIEF DESCRIPTION OF THE DRAWINGS

In order to describe embodiments of the present disclosure or technical solutions in the conventional art more clearly, reference will now be made to the accompanying drawings which are required for the description of the embodiments or the conventional art. It will be apparent that the accompanying drawings used in the description below represent merely some of the embodiments of the present disclosure, and other drawings may be obtained by those skilled in the art based on these accompanying drawings without any inventive work.

FIG. 1 is a flowchart of a method for optimizing a reservoir computing network according to an embodiment of the present disclosure;

FIG. 2 is a schematic diagram of quantifying digital signal according to an embodiment of the present disclosure;

FIG. 3 is a schematic diagram of a conventional reservoir and a reservoir constructed by virtual nodes according to an embodiment of the present disclosure;

FIG. 4 is a schematic diagram of a result of recognizing an input signal based on different quantization modes and a reservoir constructed by different virtual nodes according to an embodiment of the present disclosure;

FIG. 5 is a flowchart of a method for optimizing a reservoir computing network constructed by virtual nodes according to an embodiment of the present disclosure;

FIG. 6 is a schematic diagram of a method for optimizing a reservoir computing network constructed by virtual nodes according to an embodiment of the present disclosure; and

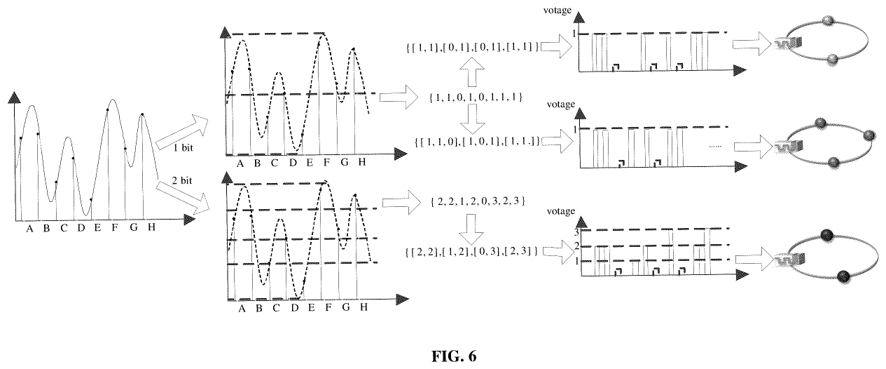

FIG. 7 is a schematic structural diagram of an apparatus for optimizing a reservoir computing network constructed by virtual nodes according to an embodiment of the present disclosure.

### DETAILED DESCRIPTION OF EMBODIMENTS

As previously described, the reservoir computing is an efficient artificial neural network suitable for processing timing signals. The reservoir computing is derived from the conventional recursive neural network RNN, but has a lower training cost and a simpler hardware implementation, and hence the reservoir computing has been widely applied in the fields of dynamic system identification, time series prediction, and the like. The computational capacity of the reservoir system is closely related to the richness of the internal state of the reservoir.

After research, the inventors have found that the current reservoir system can improve the richness of the internal state of the reservoir by the difference between the memristors. However, once the process conditions of the device are determined, the richness of the internal state of the reservoir is determined accordingly and cannot be adjusted according to the specific task. If the process conditions are adjusted according to the specific task each time, the hardware cost will be too large and the cost performance ratio will be low.

In view of the above, the present disclosure provides a method for optimizing a reservoir computing network, which can improve the differences between devices through the design of software, so as to construct different reservoirs and enrich the inner richness of the reservoirs. The method for optimizing includes: an input signal is sampled to obtain a sampled signal; a quantization process is performed on the sampled signal by at least two quantization modes to obtain at least two digital signals, and values of elements in different digital signals are different; voltage pulse signals corresponding to the elements in the different digital signals are input to reservoirs constructed by different numbers of virtual nodes, so that the different reservoirs extract signal characteristics of the input signals in different quantization modes.

It can be seen that the method performs different processing on the input signal, converts the digital signals generated in different quantization modes into an input pulse sequence, and inputs the input pulse sequence to the reservoirs, so that the same memristors can also construct different reservoirs due to different numbers or values of virtual nodes, thereby memorizing different characteristics of the signals, improving internal richness of the reservoir system, and further improving the recognition accuracy of the input signal.

In order that the present disclosure may be better understood by those skilled in the art, hereinafter technical solutions in embodiments of the present disclosure are described clearly and completely in conjunction with the drawings in embodiments of the present closure. Apparently, the described embodiments are only some rather than all of the embodiments of the present disclosure. Any other embodiments obtained based on the embodiments of the present disclosure by those skilled in the art without any creative effort fall within the scope of protection of the present disclosure.

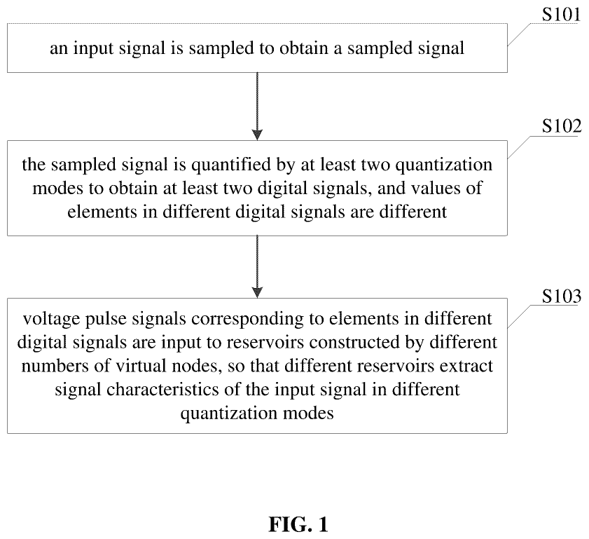

Reference is made to FIG. 1, which is a flowchart of a method for optimizing a reservoir computing network according to an embodiment of the present disclosure.

As shown in FIG. 1, the method for optimizing the reservoir computing network includes steps S101 to S103.

In the step S101, an input signal is sampled to obtain a sampled signal.

The input signal may be a variety of analog signals in the life and production. The analog signal refers to a signal that represents information through a continuously varying physical quantity and has an amplitude, frequency, or phase that varies continuously with time, or a signal of which characteristic quantities representing the information may be presented as any value at any moment within a continuous time interval, such as an image in a camera, any sound recorded by a recorder, any photograph in a camera, and pressure, rotational speed, and the like recorded in a workshop control room.

In addition, the input signal may be any digital signal, and it should be noted that the embodiment of the present disclosure does not impose any limitation on the form and content of the input signal.

Sampling refers to the discretization of a continuous signal in time, i.e., it extracts the instantaneous value of an analog signal point by point at a certain time interval. Of course, sampling may also be performed on a digital signal. In general, the higher the sampling frequency, the denser the sampling points, and the closer the resulted discrete signal is to the original signal. However, an excessively high sampling frequency is not desirable. For a signal of a fixed length (T), when an excessively large amount of data (N=T/Δt) is sampled, unnecessary calculation workload and storage space are added to the computer; if the amount of data (N) is limited, the sampling time will be too short, which may cause some data information to be excluded. If the sampling frequency is too low and the sampling interval is too long, the discrete signal is insufficient to reflect the waveform characteristics of the original signal, and the signal cannot be recovered, resulting in signal confusion. Intuitively, signal aliasing refers to the case of mistaking a high frequency signal for a low frequency signal. According to the sampling theorem, when the sampling frequency is greater than twice the highest frequency component of the original signal, the signal can be recovered back relatively well, but when the sampling frequency is less than twice the highest frequency component of the original signal, undersampling occurs, resulting in the signal aliasing.

When the input signal is the analog signal, the sampled signal may be a set of samples that are discrete in time and continuous in amplitude, and the sampled signal is actually an analog signal.

Sampling may be accomplished by a professional data acquisition device or a device of a computer system equipped with a data acquisition card.

In the step S102, the sampled signal is quantified by at least two quantization modes to obtain at least two digital signals, and values of elements in different digital signals are different.

Quantization may be the process of converting the sampled analog signal into a digital signal by rounding. As can be seen from the sampling in the step S101, when the input signal is an analog signal, the sampled signal of the input signal is a staircase signal. Although the staircase signal has been discrete on the time axis, the amplitude of the staircase signal is still continuous. If this signal is accurately represented by a binary code, an infinite number of bits of binary code is required. Therefore, a rounding method should be used to merge each sample value to an adjacent integer, so that the sample value can be represented by a binary code of a certain word length. The process of taking a finite number of values to approximately represent a continuously varying signal is called quantization. The quantization may be classified into uniform quantization and non-uniform quantization. The uniform quantization is to divide the dynamic range of the input signal uniformly. The non-uniform quantization is to divide the dynamic range of the input signal non-uniformly, and the signal is generally quantized by a curve similar to exponential curve. Non-uniform quantization is proposed for uniform quantization. For example, the majority of general speech signals are small-amplitude signals, and human hearing follows an exponential pattern. To ensure that the signal can be more accurately recovered, more bits should be used to represent small signals.

The quantization mode in the embodiment of the present disclosure can select an appropriate number of bits according to the characteristics of the memristor, where the higher the number of bits, the closer the quantized result is to the original input signal, that is, the lower the degree of distortion. The quantization mode and the number of virtual nodes together determine the richness of the internal state of the reservoir. Specifically, when the selection of the quantization mode is x bits and the number of virtual nodes is n, there are (2^{x})ⁿ types of internal states of the reservoir, that is, (2^{x})ⁿ states which can be distinguished from each other are required for the memristor used to construct the reservoir. Within the allowable range of the memristor characteristics, the most appropriate values of x and n are determined by simulation according to the specific task to be performed.

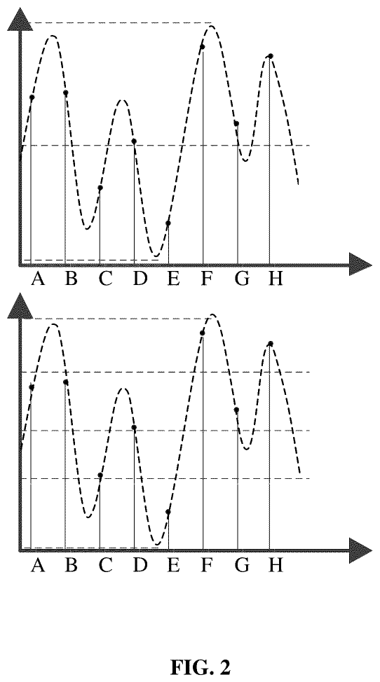

To facilitate understanding of the quantization process of the sampled signal, the quantization is now described with reference to FIG. 2 for the present specification, in which 1-bit and 2-bite quantization modes are shown, the 1-bit quantization mode is shown in an upper figure, and the 2-bite quantization mode is shown in a lower figure.

When the quantization is performed in the 1-bit quantization mode, a set of digital signals can be obtained, and can be represented as {1, 1, 0, 1, 0, 1, 1, 1};

When the quantization is performed in the 2-bit quantization mode, a set of digital signals can be obtained, and can be represented as {2, 2, 1, 2, 0, 3, 2, 3}.

In the step S103, voltage pulse signals corresponding to elements in different digital signals are input to reservoirs constructed by different numbers of virtual nodes, so that different reservoirs extract signal characteristics of the input signal in different quantization modes.

The reservoir computing RC derived from the conventional cyclic neural network RNN has been widely used in the fields of dynamic system identification, time series detection, and the like because of RC having low training cost and simple hardware implementation.

The reservoir may extract the signal characteristics of the input signal in different quantization modes through a memristor.

The full name of the memristor is memory resistor. The memristor is a circuit device that represents the relationship between magnetic flux and charge. The memristor has a dimension of the resistance, but unlike the resistance, the resistance value of the memristor is determined by the charge flowing through it. Therefore, by measuring the resistance value of the memristor, it is possible to know the amount of charge flowing through the memristor, and hence the memristor has the function of memorizing the charge.

For the sake of case of understanding, the construction of the reservoir will be described in detail below. The number of virtual nodes for constructing the reservoir and the number of reservoirs are not limited in the embodiments of the present disclosure.

Conventional reservoir computing may include three layers, such as an input layer, a reservoir layer, and an output layer. The input layer inputs an input signal to the reservoir layer through a fixed random weight connection. The reservoir layer is typically composed of a large number of non-linear nodes that are randomly connected, forming a recurrent network, i.e., a network with internal feedback loops. Under the influence of the input signal, the network generates transient responses, which are read by a linear weighted sum of the states of a single node at the output layer. The goal of RC is to achieve a specific non-linear transformation of the input signal or to classify the input signal. Classification involves differences between a set of input data, such as identifying features such as images, sounds, time series, etc.

The input signal is non-linearly converted into a high-dimensional state space in which the signal is represented. This is achieved by a large number of nodes of the reservoir layer, which are interconnected based on periodic non-linear reservoir dynamics. In practice, the conventional RC structure achieves good performance with hundreds/thousands of non-linear nodes of the reservoir layer.

An embodiment of the present disclosure provides a reservoir layer computer in which the structure, in which a plurality of nodes are connected, is replaced by a dynamic system including a non-linear node subject to delayed feedback. Mathematically, a key feature of a continuous time-delay system is that state space of the continuous time-delay system becomes infinite-dimensional, since a state at time t in the continuous time-delay system depends on states of a non-linear node in a consecutive time intervals [t−τ, t], where τ refers to a delay time. In practice, the dynamics of the delay system is still finite-dimensional, but exhibit high dimensional and short-term memory characteristics. Therefore, the delay system can meet the requirements for normal operation of the reservoir layer.

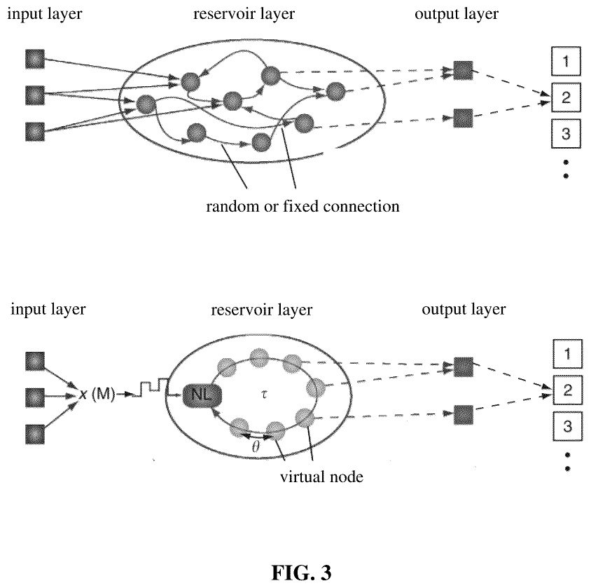

The principle of constructing a reservoir according to an embodiment of the present disclosure is described in conjunction with FIG. 3 for the specification. In a delay interval of length τ, N equidistant points in time are defined by a formula θ=τ/N. These N equidistant points are referred to as “virtual nodes”, because these N equidistant points have a function similar to that of one of nodes in a conventional reservoir layer. Values of a delay variable at every N points define states of the virtual nodes. These states characterize a transient response of the reservoir layer to a given input at a given time. The interval time θ between the virtual nodes is important and can be used to optimize reservoir dynamics. In an embodiment of the present disclosure, the interval time is selected such that θ<T, where T refers to a characteristic time scale of the nonlinear node. With this selection, the state of the virtual node becomes dependent on a state of a neighboring node. The virtual nodes are connected in this way to simulate a network acting as a storage.

Generally, the richness of the internal state of the reservoir is reflected by the number of virtual nodes in the reservoir and the input signals calculated in the reservoir. In an embodiment of the present application, the reservoir system is composed of three reservoirs, in which each of reservoirs A and C is constructed by two virtual nodes, and a reservoir B is constructed by three virtual nodes. When a voltage pulse signal corresponding to a 1-bit quantized digital signal is input to the reservoir A, there are 2² internal states in the reservoir A. When a voltage pulse signal corresponding to the 1-bit quantized digital signal is input to the reservoir B, there are 2³ internal states in the reservoir B. When the 2-bit quantized digital signal is input to the reservoir C, there are (2²)² internal states in the reservoir C.

By inputting voltage pulses corresponding to different digital signals to reservoirs constructed by different numbers of virtual nodes, more accurate features at the same time point can be extracted. For example, a the 1-bit quantized digital signal {1, 1, 0, 1, 0, 1, 1, 1} and a the 2-bit quantized digital signal {2, 2, 1, 2, 0, 3, 2, 3} are respectively inputted to the reservoir A and the reservoir C, each of which is constructed by two virtual nodes. It is apparent that the 2-bit quantized digital signal is more accurate than the 1-bit quantized digital signal. In addition, there are 2² internal states in the reservoir A, there are (2²)² internal states in the reservoir C, and the internal states of the reservoir C are different from those of the reservoir A. Therefore, it is possible for the reservoir system to extract different characteristics of the same signal.

First, the input signal is sampled to obtain a sampled signal. Then, the sampled signal is quantified by at least two quantization methods to obtain at least two digital signals, and values of elements in different digital signals are different. Finally, voltage pulse signals corresponding to the elements in the different digital signals are input to reservoirs that are constructed by different numbers of virtual nodes, so that memristors in the different reservoirs record signal characteristics of the input signal in different quantization modes.

According to the present disclosure, different reservoirs are constructed by different numbers of virtual nodes, different digital signals are obtained by performing different quantization processing on the sampled signal in different quantization modes, and the different digital signals are input to the different reservoirs that are constructed by different numbers of virtual nodes, so that the richness of the reservoirs is improved, and the accuracy of identifying input signals by the reservoir system is improved.

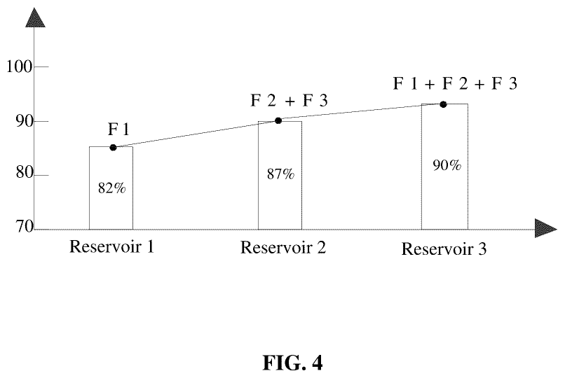

An advantageous effect is described in conjunction with FIG. 4 for the specification, in which “F1” indicates the case where the 1-bit quantization mode is applied and the reservoir is constructed by two virtual nodes, “F2” indicates the case where the 1-bit quantization mode is applied and the reservoir is constructed by three virtual nodes, and “F3” indicates the case where the 2-bit quantization mode is applied and the reservoir is constructed by two virtual nodes.

Based on the preprocessing mode and the construction of the reservoir network as described above, a dynamic gesture recognition task of the mobile phone is selected for verification. The final system recognition accuracy indicates that the accuracy was 82% when only “F1” was applied to the verification task, the accuracy was improved by 5% and reached 87% when both “F2” and “F3” were applied to the verification task, and the accuracy reached 90% when the verification task was performed using three modes of “F1”, “F2” and “F3” together.

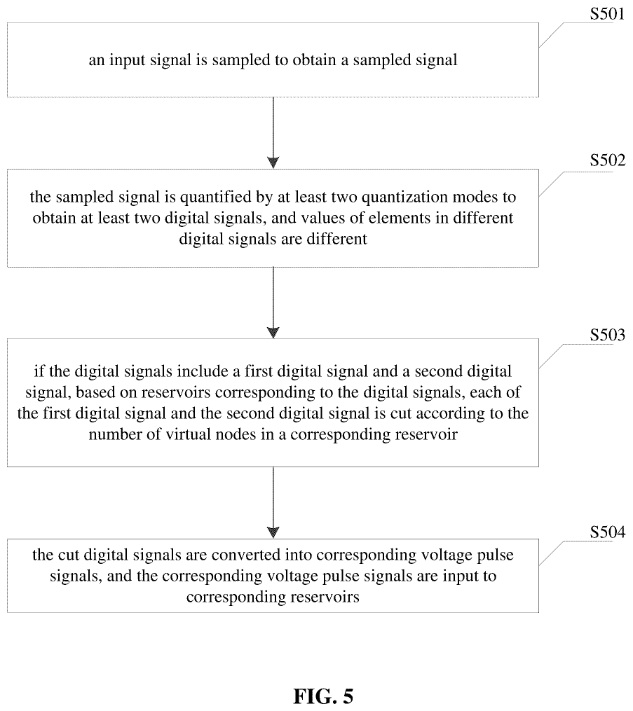

Reference is made to FIG. 5, which is a flowchart of a method for optimizing a reservoir computing network constructed by virtual nodes according to an embodiment of the present disclosure.

As shown in FIG. 5, the method for optimizing the reservoir computing network includes following steps S501 to S504.

In the step S501, an input signal is sampled according to Nyquist theorem to obtain a sampled signal.

The Nyquist sampling theorem states that the sampling frequency should be greater than twice the highest frequency of the signal, so as to recover the original signal from the sampled signal without distortion. When the sampling frequency is less than twice the highest frequency of the spectrum, there is aliasing in the spectrum of the signal. When the sampling frequency is greater than twice the highest frequency of the spectrum, there is no aliasing in the spectrum of the signal.

In the step S502, the sampled signal is quantified by at least two quantization modes to obtain at least two digital signals, and values of elements in different digital signals are different.

Quantization may be a process of converting the sampled analog signal into a digital signal by rounding. It can be seen from the sampling process in the step S501 that the sampled signal of the input signal is a staircase signal. Although the staircase signal has been discrete on the time axis, the amplitude of the staircase signal is still continuous. If this signal is accurately represented by a binary code, an infinite number of bits of binary code is required. Therefore, a rounding method should be used to merge each sample value to an adjacent integer, so that the sample value can be represented by a binary code of a certain word length. The process of taking a finite number of values to approximately represent a continuously varying signal is called quantization.

The quantization may be classified into uniform quantization and non-uniform quantization. The uniform quantization is to divide the dynamic range of the input signal uniformly. The non-uniform quantization is to divide the dynamic range of the input signal non-uniformly, and the signal is generally quantized by a curve similar to exponential curve. Non-uniform quantization is proposed for uniform quantization. For example, the majority of general speech signals are small-amplitude signals, and human hearing follows an exponential pattern. To ensure that the signal can be more accurately recovered, more bits should be used to represent small signals.

For case of understanding, quantization will be described with reference to FIG. 2 for the present specification and explained based on two quantization modes such as 1-bit and 2-bite quantization modes, the 1-bit quantization mode is shown in an upper figure, and the 2-bite quantization mode is shown in a lower figure.

When the quantization is performed in the 1-bit quantization mode, a set of digital signals can be obtained, which can be represented as {1, 1, 0, 1, 0, 1, 1, 1};

When the quantization is performed in the 2-bit quantization mode, a set of digital signals can be obtained, which can be represented as {2, 2, 1, 2, 0, 3, 2, 3}. In the step S503, if the digital signals include a first digital signal and a second digital signal, based on reservoirs corresponding to the digital signals, each of the first digital signal and the second digital signal is cut according to the number of virtual nodes in a corresponding reservoir.

For ease of understanding, the process of cutting the digital signal is described by way of example.

Assuming that the first digital signal is {1, 1, 0, 1, 0, 1, 1, 1} and input to a reservoir A constructed by two virtual nodes and a reservoir B constructed by three virtual nodes, and the second digital signal is {2, 2, 1, 2, 0, 3, 2, 3} and input to a reservoir C constructed by two virtual nodes.

The first digital signal is cut according to the number of virtual nodes in the reservoirs A and B, and the cut digital signals are {[1, 1], [0, 1], [0, 1], [1, 1]}, {[1, 1, 0], [1, 0, 1], [1, 1]}. The second digital signal is cut according to the number of virtual nodes in the reservoir C, and the cut digital signal is {[2, 2], [1, 2], [0, 3], [2, 3]}.

In the step S504, the cut digital signals are converted into corresponding voltage pulse signals, and the corresponding voltage pulse signals are input to corresponding reservoirs.

Since the signal is ultimately to be output to the memristor, it is necessary to convert the digital signal into a corresponding voltage pulse signal before outputting the signal to the memristor.

There are 2² internal states in the reservoir A, there are 2³ internal states in the reservoir B, and there are (2²)² internal states in the reservoir C.

By inputting the voltage pulse signals corresponding to the cut digital signals into the corresponding reservoirs, the following two functions are mainly achieved: firstly, the voltage pulses corresponding to the same set of digital signals are input to the reservoirs constructed by different numbers of virtual nodes, and the memristors in the different reservoirs can memorize characteristics of the signal in different time dimensions (for example, the voltage pulses corresponding to the first digital signal are input to the reservoir A constructed by the two virtual nodes and the reservoir B constructed by the three virtual nodes); secondly, different digital signals are input to the reservoirs constructed by the same number of virtual nodes, and different characteristics of the signal at the same time point can be abstracted (for example, voltage pulses corresponding to the first digital signal are input to the reservoir A constructed by the two virtual nodes, and voltage pulses corresponding to the second digital signal are input to the reservoir C constructed by the two virtual nodes).

As can be seen from the above two embodiments, the quantization mode and the number of virtual nodes for constructing the reservoir can be adjusted according to the input signal (identification task) in the present disclosure, which will not increase the hardware overhead, and is a relatively flexible method.

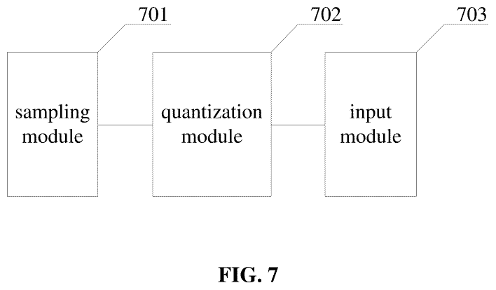

Reference is made to FIG. 7, which is a schematic structural diagram of an apparatus for optimizing a reservoir computing network constructed by virtual nodes according to an embodiment of the present disclosure.

As shown in FIG. 7, the apparatus for optimizing the reservoir computing network includes a sampling module 701, a quantization module 702, and an input module 703.

The sampling module 701 is configured to sample an input signal to obtain a sampled signal.

The quantization module 702 is configured to quantify the sampled signal by at least two quantization modes to obtain at least two digital signals, and values of elements in different digital signals are different.

The input module 703 is configured to input voltage pulse signals corresponding to elements in different digital signals to reservoirs constructed by different numbers of virtual nodes, so that memristors in the different reservoirs record signal characteristics of the input signal in different quantization modes.

The at least two digital signals include a first digital signal and a second digital signal, and the input module 703 is specifically configured to:
sequentially input voltage pulse signals corresponding to a first number of elements in the first digital signal to a first reservoir constructed by a first number of virtual nodes; and
sequentially input voltage pulse signals corresponding to a second number of elements in the second digital signal to a second reservoir constructed by a second number of virtual nodes.

At least two quantization modes include at least a first quantization mode and a second quantization mode. The first quantization mode corresponds to a first bit number, and the second quantization mode corresponds to a second bit number. The sampled signals are quantified by the at least two quantization modes to obtain the at least two digital signals. The quantization module 702 is specifically configured to:
determine a first value interval, based on a maximum value and a minimum value of the sampled signal, and the first bit number;
obtain a first digital signal according to a correspondence between an amplitude of the sampled signal and the first value interval;
determine a second value interval, based on a maximum value and a minimum value of the sampled signal, and the second bit number; and
obtain a second digital signal according to a correspondence between the amplitude of the sampled signal and the second value interval.

It should be noted that various embodiments in the present specification have been described in a progressive manner, the same and similar parts among the various embodiments can be referred to each other, and each embodiment focuses on the differences from other embodiments. In particular, for the apparatus and system embodiments, since they are substantially similar to the method embodiment, the description of the apparatus and system embodiments is relatively simple, and reference may be made to the partial description of the method embodiment. The apparatus and system embodiments as described above are merely illustrative, the elements illustrated as separate components in the apparatus and system may or may not be physically separate, and the elements indicated as units may or may not be physical units, that is, they may be located at one location, or may be distributed across multiple network units. Some or all of the modules may be selected according to actual needs to achieve the purpose of the embodiment. Those of ordinary skilled in the art will understand and implement it without inventive effort.

The foregoing description is only a specific embodiment of the present disclosure, but the protective scope of the present disclosure is not limited thereto. Various modifications or substitutions that can be easily conceived by a person skilled in the art within the technical scope disclosed in the present disclosure should fall within the scope of protection of the present disclosure. Therefore, the protective scope of the present disclosure should be subject to the scope of protection of the claims.

1. A method for optimizing a reservoir computing network, comprising:
sampling an input signal to obtain a sampled signal;
performing a quantization processing on the sampled signal by at least two quantization modes to obtain at least two digital signals, wherein values of elements in different digital signals are different; and
inputting voltage pulse signals corresponding to the elements in the different digital signals to reservoirs constructed by different numbers of virtual nodes, so that different reservoirs extract signal characteristics of the input signal in different quantization modes.

2. The method according to claim 1, wherein the at least two digital signals comprise at least a first digital signal and a second digital signal, and inputting the voltage pulse signals corresponding to the elements in the different digital signals to the reservoirs constructed by the different numbers of virtual nodes comprises:
inputting voltage pulse signals corresponding to a first number of elements in the first digital signal to a first reservoir constructed by a first number of virtual nodes, in sequence; and
inputting voltage pulse signals corresponding to a second number of elements in the second digital signal to a second reservoir constructed by a second number of virtual nodes, in sequence.

3. The method according to claim 1, wherein the at least two quantization modes comprise at least a first quantization mode and a second quantization mode, the first quantization mode corresponds to a first bit number, the second quantization mode corresponds to a second bit number, and performing the quantization processing on the sampled signal by the at least two quantization modes to obtain the at least two digital signals comprises:
determining a first value interval, based on a maximum value and a minimum value of the sampled signal and the first bit number;
obtaining a first digital signal according to a correspondence between an amplitude of the sampled signal and the first value interval;
determining a second value range, based on a maximum value and a minimum value of the sampled signal, and the second bit number; and
obtaining a second digital signal according to a correspondence between the amplitude of the sampled signal and the second value interval.

4. The method according to claim 1, wherein bit number applied in the quantization modes is related to performance of a memristor.

5. The method according to claim 1, wherein the digital signals are binary encoded digital signals.

6. An apparatus for optimizing a reservoir computing network, comprising a sampling module, a quantization module, and an input module, wherein,
the sampling module is configured to sample an input signal to obtain a sampled signal;
the quantization module is configured to quantify the sampled signal by at least two quantization modes to obtain at least two digital signals, wherein values of elements in different digital signals are different; and
the input module is configured to input voltage pulse signals corresponding to the elements in the different digital signals to reservoirs constructed by different numbers of virtual nodes, so that different reservoirs extract signal characteristics of the input signal in different quantization modes.

7. The apparatus according to claim 6, wherein the at least two digital signals comprise a first digital signal and a second digital signal, and the input module is further configured to:
input voltage pulse signals corresponding to a first number of elements in the first digital signal to a first reservoir constructed by a first number of virtual nodes, in sequence; and
input voltage pulse signals corresponding to a second number of elements in the second digital signal to a second reservoir constructed by a second number of virtual nodes, in sequence.

8. The apparatus according to claim 6, wherein the at least two quantization modes comprise at least a first quantization mode and a second quantization mode, the first quantization mode corresponds to a first bit number, the second quantization mode corresponds to a second bit number, and the quantization module is further configured to:
determine a first value interval, based on a maximum value and a minimum value of the sampled signal and the first bit number;
obtain a first digital signal according to a correspondence between an amplitude of the sampled signal and the first value interval;
determine a second value range, based on a maximum value and a minimum value of the sampled signal, and the second bit number; and
obtain a second digital signal according to a correspondence between the amplitude of the sampled signal and the second value interval.

9. A device for optimizing a reservoir computing network, comprising: a memory and a processor, wherein,
the memory is configure to store a computer program;
the processor is configured, when executing the computer program, to implement steps of the method for optimizing the reservoir computing network according to claim 1.

10. A computer readable storage medium storing a computer program, which, when the program is executed by a processor, causes the processor to implement steps of the method for optimizing the reservoir computing network according to claim 1.
